(19) United States
(12) Patent Application Publication
(10) Pub. No.: US 2024/0213714 A1
(43) Pub. Date: Jun. 27, 2024

(54) ELECTRICAL CONNECTOR

(71) Applicant: J.S.T. Mfg. Co., Ltd., Tokyo (JP)

(72) Inventor: Masaki TSUJIMOTO, Yokohama-shi (JP)

(73) Assignee: J.S.T. Mfg. Co., Ltd., Tokyo (JP)

(21) Appl. No.: 18/524,865

(22) Filed: Nov. 30, 2023

(30) Foreign Application Priority Data
Dec. 23, 2022 (JP) 2022-207039

(51) Int. Cl. H01R 13/629; H01R 13/627

(52) U.S. Cl. CPC H01R 13/629; H01R 13/6272

(57) ABSTRACT

Provided is an electrical connector capable of suppressing damage to a contact and facilitating insertion of a plug connector into an insertion opening. A base connector (10), which has an insertion opening (13a) into which a plug connector (2) is inserted, includes a pair of guide portions (14b) that are provided so as to be capable of protruding and retracting from both width-direction sides of the insertion opening (13a), and that guide both width-direction sides of the plug connector (2) that moves toward the insertion opening (13a).

This application is based on and claims benefit of priority from Japanese Patent Application No. 2022-207039, filed on 23 Dec. 2022, the content of which is incorporated herein by reference.

### BACKGROUND OF THE INVENTION

### Field of the Invention

The present invention relates to an electrical connector having an insertion opening into which a plug connector is inserted.

### Related Art

As a conventional electrical connector, for example, a base connector mounted on a substrate housed in a housing of a device such as a personal computer and having an insertion opening into which a plug connector is inserted is known (for example, see Patent Document 1).

Patent Document 1: Japanese Unexamined Patent Application, Publication No. H08-167450

### SUMMARY OF THE INVENTION

With respect to the conventional electric connector, when the insertion opening is not directed to the front of the operator who performs plug insertion operation that is the operation of inserting the plug connector into the insertion opening, it is difficult for the operator to accurately visually recognize the position of the insertion opening and thus the workability of the plug insertion operation may be reduced. In addition, when contacts are disposed in the vicinity of the insertion opening, the corner portion of the leading end side of the plug connector may contact the contacts during the plug insertion operation, and the contacts may be deformed.

It is an object of the present invention to provide an electrical connector that can suppress damage to a contact and facilitate insertion of a plug connector into an insertion opening.

An electrical connector according to the present invention having an insertion opening into which a plug connector is inserted, includes a pair of guide portions provided so as to be capable of protruding and retracting from both width-direction sides of the insertion opening. The pair of guide portions are configured to guide both width-direction sides of the plug connector that moves toward the insertion opening.

In the electrical connector according to the present invention, the pair of guide portions are integrally formed with a main body portion configured to move to open and close the insertion opening. The pair of guide portions protrude from the both width-direction sides of the insertion opening as the main body portion moves to open the insertion opening.

In the electrical connector according to the present invention, the main body portion includes a locking portion configured to lock the plug connector inserted into the insertion opening.

The electrical connector according to the present invention further includes a posture holding structure configured to hold a posture of the pair of guide portions in a protruded or retracted position with respect to the insertion opening.

In the electrical connector according to the present invention, the pair of guide portions each are made of a conductive member and are connected to ground.

In the electrical connector according to the present invention, the pair of guide portions each include a contact portion that contacts the plug connector inserted into the insertion opening.

According to the present invention, when the plug connector is inserted into the insertion opening, the plug connector can be guided in a width direction toward the insertion opening and inserted into the insertion opening in an appropriate posture, so that damage to the contact can be suppressed and the operation of inserting the plug connector into the insertion opening can be easily performed.

### BRIEF DESCRIPTION OF THE DRAWINGS

FIG. 1 is a perspective view of a base connector and a plug connector according to a first embodiment of the present invention;

FIG. 2 is a perspective view of the base connector according to the first embodiment of the present invention;

FIG. 3 is an exploded perspective view of the base connector according to the first embodiment of the present invention;

FIGS. 4A and 4B are diagrams illustrating the posture holding structure according to the first embodiment of the present invention;

FIGS. 5A and 5B are diagrams illustrating the posture holding structure according to the first embodiment of the present invention;

FIGS. 6A and 6B are diagrams illustrating the posture holding structure according to the first embodiment of the present invention;

FIG. 7 is a perspective view illustrating an operation of inserting the plug connector into the base connector according to the first embodiment of the present invention;

FIG. 8 is a diagram showing a relationship between the contacts of the base connector and the plug connector according to the first embodiment of the present invention;

FIG. 9 is a sectional view showing a relationship between the base connector and the plug connector according to the first embodiment of the present invention;

FIG. 10 is a perspective view of a device on which the base connector is mounted according to the first embodiment of the present invention;

FIG. 11 is an elevation view of the main part of the device on which the base connector is mounted according to the first embodiment of the present invention;

FIG. 12 is an elevation sectional view of the main part of the device on which the base connector is mounted according to the first embodiment of the present invention; and

FIG. 13 is a perspective view of a base connector and a plug connector according to a third embodiment of the present invention.

### DETAILED DESCRIPTION OF THE INVENTION

### First Embodiment

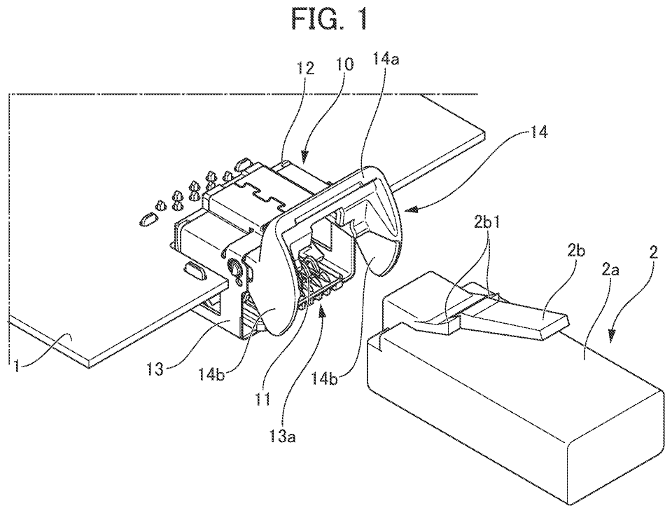

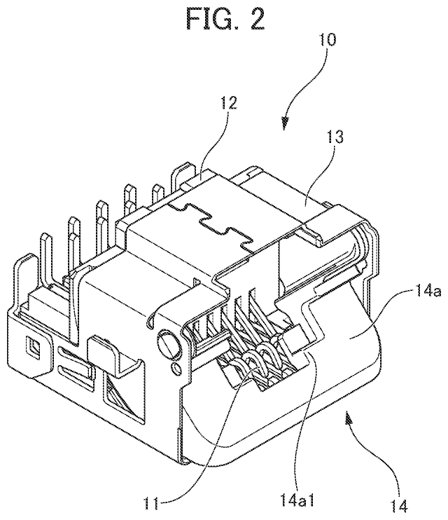

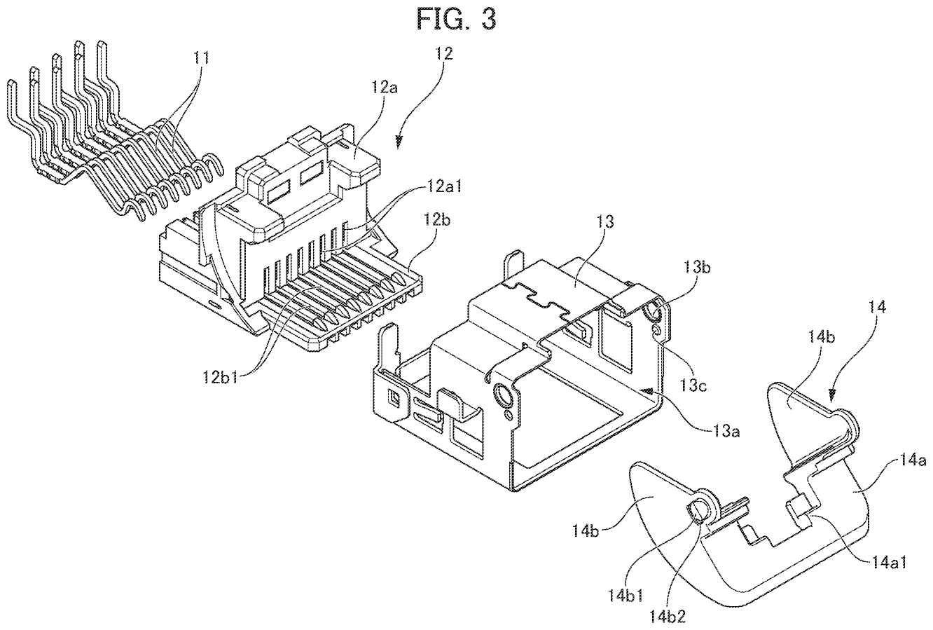

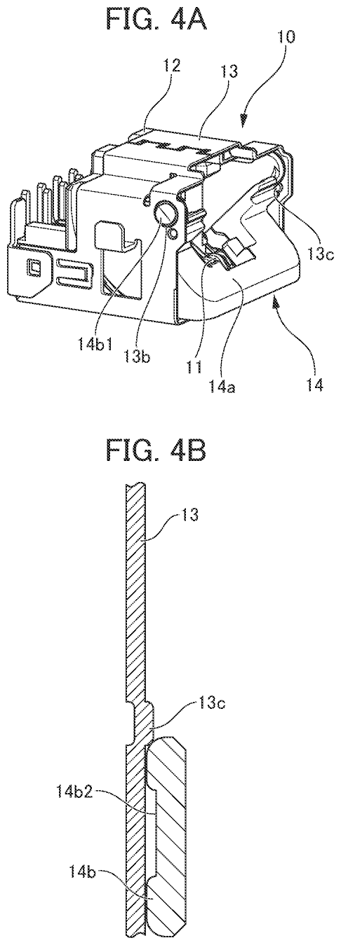

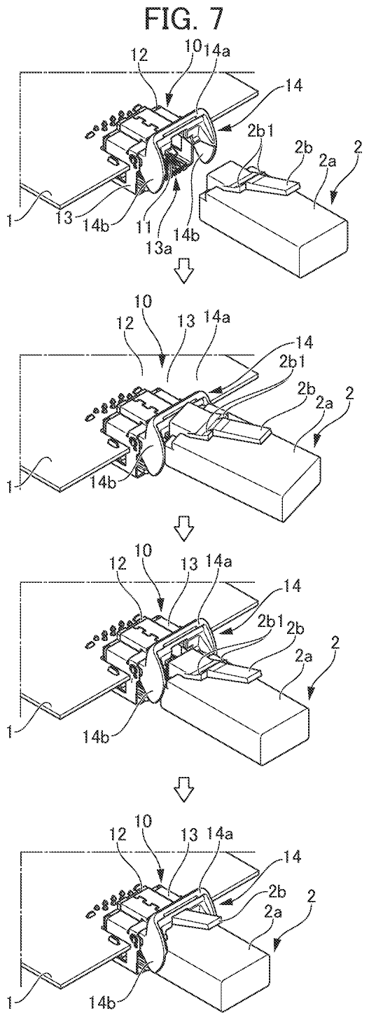

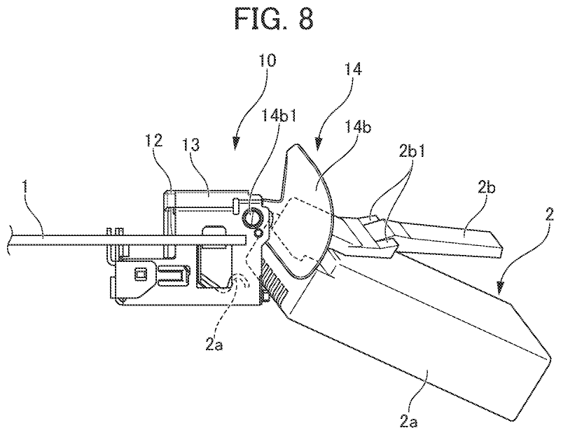

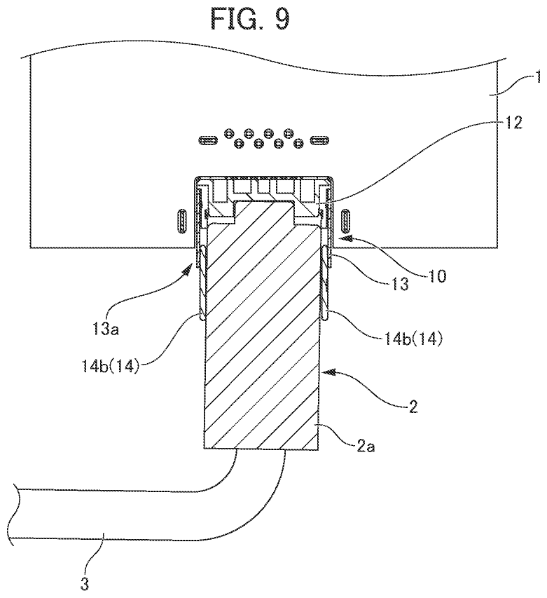

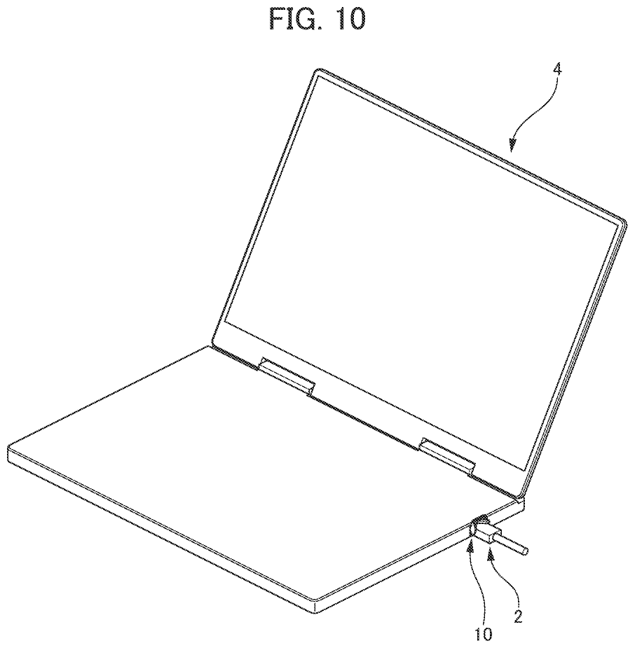

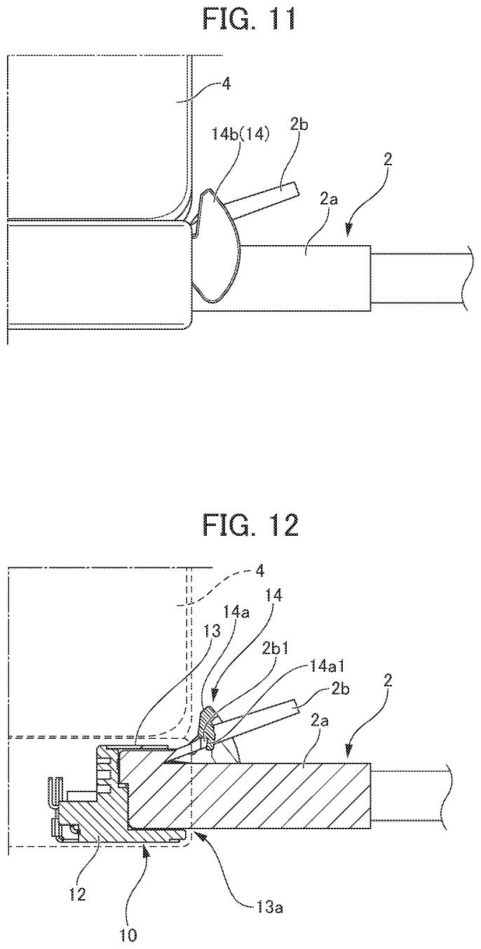

FIGS. 1 to 12 show a first embodiment of the present invention. FIG. 1 is a perspective view of a base connector and a plug connector. FIG. 2 is a perspective view of the base connector. FIG. 3 is an exploded perspective view of the base connector. FIGS. 4A to 6B are diagrams illustrating a posture holding structure. FIG. 7 is a perspective view illustrating an operation of inserting the plug connector into the base connector. FIG. 8 is a diagram showing a relationship between the contacts of the base connector and the plug connector. FIG. 9 is a sectional view showing a relationship between the base connector and the plug connector. FIG. 10 is a perspective view of a device on which the base connector is mounted. FIG. 11 is an elevation view of the main part of the device on which the base connector is mounted. FIG. 12 is an elevation sectional view of the main part of the device on which the base connector is mounted. In the present embodiment, the outer side is defined as a front side and the inner side is defined as a rear side with respect to an insertion opening described later.

As shown in FIG. 1, an electrical connector of the present embodiment is, for example, a base connector 10 mounted on a substrate 1 provided in a device such as a personal computer. The base connector 10 couples with a plug connector 2 attached to an end portion of a communication cable to be connected to the device, whereby the substrate 1 and a substrate provided in another device are electrically connected to each other via the communication cable. The devices connected via the communication cable can transmit and receive signals to and from each other.

Here, as shown in FIG. 1, the plug connector 2 includes a rectangular parallelepiped-shaped housing 2a having a plurality of contacts (not shown) attached to the leading end side, and an operation lever 2b that is operated when the plug connector 2 is removed from the base connector 10. The operation lever 2b is made of an elastic member, and one end portion thereof is coupled to the leading end portion of the housing 2a. The operation lever 2b extends linearly on the upper surface side of the housing 2a toward the base end side, and the other end portion thereof is positioned above the base end side of the housing 2a. On one end side of the operation lever 2b, engagement portions 2b1 that are formed on both sides in the width direction and that engage with members on the side of the base connector 10 are provided. The engagements of the engagement portions 2b1 with the members on the base connector 10 side are released by the operation of pressing the other end side of the operation lever 2b, and the plug connector 2 can be removed from the base connector 10.

As shown in FIGS. 2 and 3, the base connector 10 includes a plurality of contacts 11, a housing 12 to which the plurality of contacts 11 are attached, a shell 13 having an insertion opening 13a to which the plug connector 2 is inserted and for covering the outside of the housing 12, and a cover 14 for openably covering the insertion opening 13a of the shell 13.

Each of the plurality of contacts 11 is, for example, a linear member formed by cutting and bending a conductive metal plate such as a copper alloy by press working or the like. The base end sides of the plurality of contacts 11 are bonded to the substrate 1 by soldering or the like, and the leading end side thereof is positioned in the vicinity of the insertion opening 13a. Each of a plurality of contacts of the plug connector 2 inserted from the insertion opening 13a contacts the leading end side of each of the plurality of contacts 11.

The housing 12 is made of, for example, an insulating resin member such as nylon. The housing 12 includes a base end side holding portion 12a for holding the base end sides of the plurality of contacts 11, and a leading end side holding portion 12b extending forward from a lower portion of the base end side holding portion 12a and for holding the leading end sides of the plurality of contacts 11.

The base end side holding portion 12a faces the leading end portion of the plug connector 2 inserted from the insertion opening 13a. A plurality of attachment holes 12a1 penetrating in the front-rear direction and to which the plurality of contacts 11 are respectively attached are formed in the base end side holding portion 12a.

The leading end side holding portion 12b faces the lower surface of the leading end side of the plug connector 2 inserted from the insertion opening 13a. On the upper surface of the leading end side holding portion 12b, a plurality of housing grooves 12b1 for housing the leading end sides of the plurality of contacts 11 attached to the attachment holes 12a1 of the base end side holding portion 12a are formed. With respect to the contact 11 housed in the housing groove 12b1, a portion located on the center portion side of the housing groove 12b1 in the front-rear direction protrudes upward from the housing groove 12b1, and the contact of the plug connector 2 can contact the portion.

The shell 13 is formed in a rectangular tube shape having a front surface and a rear surface opened by bending a conductive metal plate. The opening on the front surface side of the shell 13 serves as the insertion opening 13a into which the plug connector 2 is inserted. Support portions 13b that rotatably support the cover 14 are provided at upper portions on both width-direction sides of the front side of the shell 13. There are provided posture holding protrusions 13c as posture holding structures that protrude inward in the width direction so as to be engageable with the cover 14 and hold the posture of the cover 14 in a state where the insertion opening 13a is closed or opened, below the support portions 13b on the both width-direction sides of the front side of the shell 13.

The cover 14 is made of, for example, a resin member. As shown in FIG. 3, the cover 14 includes a main body portion 14a, and a pair of guide portions 14b in the width direction. The main body portion 14a opens and closes the insertion opening 13a. The pair of guide portions 14b are positioned on the outer sides in the width direction and forward of the insertion opening 13a when the main body portion 14a opens the insertion opening 13a, and guide both width-direction sides of the plug connector 2 inserted into the insertion opening 13a.

The entire lower portion side of the main body portion 14a protrudes forward when the insertion opening 13a is closed, allowing the user to place a finger on the main body portion 14a when opening the insertion opening 13a. Locking portions 14a1 are formed in the central portion in the width direction of the upper side of the main body portion 14a. The locking portions 14a1 are engageable with the engagement portions 2b1 of the plug connector 2 and locks the plug connector 2 inserted into the insertion opening 13a.

The pair of guide portions 14b are disposed on the outside of the main body portion 14a in the width direction. In a posture in which the main body portion 14a closes the insertion opening 13a, the pair of guide portions 14b protrude rearward from both width-direction sides of the main body portion 14a and are positioned inside the insertion opening 13a. The guide portion 14b is formed in a fan shape. Support shafts 14b1 for rotatably supporting the cover 14 on the support portions 13b of the shell 13 are respectively provided on the upper sides of the pair of guide portions 14b. Protrusion housing recesses 14b2 capable of housing the posture holding protrusions 13c are respectively provided below the support shafts 14b1 of the pair of guide portions 14b.

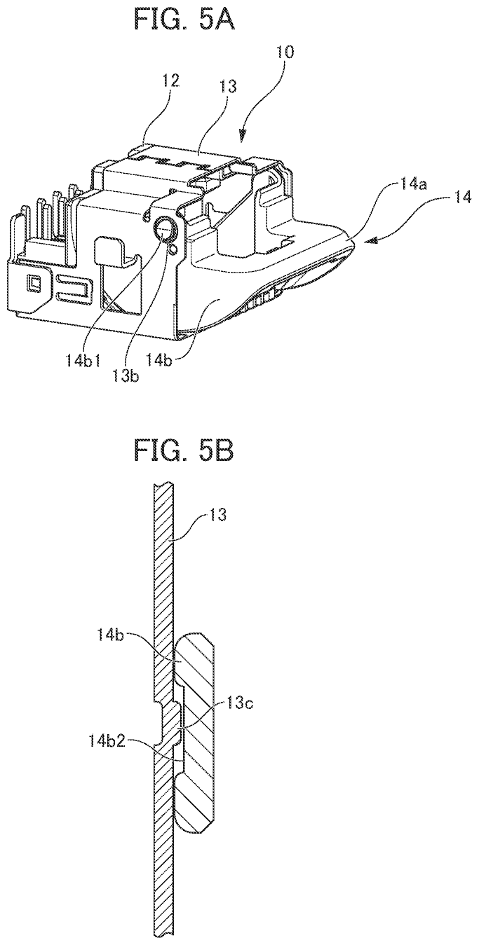

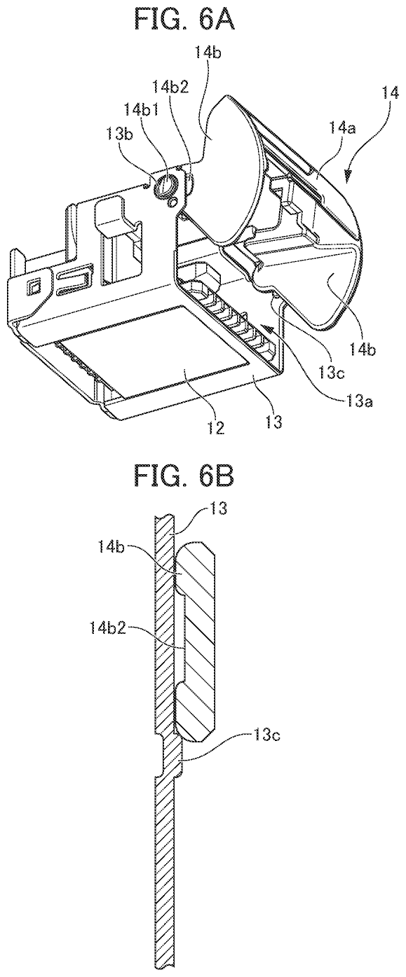

Here, as shown in FIGS. 4A and 4B, in a state in which the main body portion 14a closes the insertion opening 13a, the posture holding protrusions 13c of the shell 13 are positioned in front of the pair of guide portions 14b and hold the posture in which the main body portion 14a closes the insertion opening 13a. As shown in FIGS. 6A and 6B, in a state in which the main body portion 14a opens the insertion opening 13a, the posture holding protrusions 13c are positioned below the pair of guide portions 14b, and holds the posture in which the main body portion 14a opens the insertion opening 13a. As shown in FIGS. 5A and 5B, between the state in which the main body portion 14a closes the insertion opening 13a and the state in which the main body portion 14a opens the insertion opening 13a, the posture holding protrusion 13c is positioned in the protrusion housing recess 14b2, and the cover 14 is rotatable within the range of the protrusion housing recess 14b2.

With respect to the base connector 10 configured as described above, when the plug connector 2 is inserted into the base connector 10, the cover 14 is rotated upward to open the insertion opening 13a, and as shown in FIG. 7, the plug connector 2 is inserted into the insertion opening 13a.

When the plug connector 2 is inserted into the insertion opening 13a, the guide portions 14b are positioned on both width-direction sides in front of the insertion opening 13a. Thus, when the plug connector 2 inclined with respect to the insertion opening 13a is brought close to the insertion opening 13a, insertion of the plug connector 2 into the insertion opening 13a is prevented by the guide portions 14b on both width-direction sides. When the plug connector 2 moving toward the insertion opening 13a changes its orientation with respect to the insertion opening 13a by contacting the pair of guide portions 14b and takes an insertable posture, both width-direction sides thereof are guided by the pair of guide portions 14b and the plug connector 2 can be inserted from the insertion opening 13a.

Here, in the vicinity of the insertion opening 13a of the base connector 10, the leading end sides of the plurality of contacts 11 are positioned. Thus, when the plug connector 2 is attempted to be inserted obliquely into the insertion opening 13a, the corner portion of the leading end side of the plug connector 2 may enter the insertion opening 13a and contact the contacts 11. However, since the guide portions 14b protrude from the insertion opening 13a on both width-direction sides of the insertion opening 13a of the base connector 10, as shown in FIG. 8, the insertion of the corner portion of the leading end side of the plug connector 2 into the insertion opening 13a is regulated by the pair of guide portions 14b, and deformation of the contacts 11 is suppressed.

As shown in FIG. 9, both width-direction sides of the leading end side of the plug connector 2 connected to the base connector 10 are surrounded by the guide portions 14b. Therefore, when a force toward the width direction of the insertion opening 13a acts on a communication cable 3 connected to the plug connector 2, the side surfaces of the leading end side of the plug connector 2 connected to the base connector 10 are supported by the guide portions 14b. Therefore, the plug connector 2 is prevented from being misaligned and falling out of position with the base connector 10.

As shown in FIG. 10, the base connector 10 is provided in a device 4 such as a personal computer, for example. At this time, as shown in FIG. 11, in the plug connector 2 coupled to the base connector 10, one end side of the operation lever 2b is positioned inside the device and the other end side is positioned outside the device. As shown in FIG. 12, the engagement portion 2b1 of the operation lever 2b engages with the locking portion 14a1 of the main body portion 14a of the cover 14 outside the device 4. Therefore, according to the electrical connector of the present embodiment, the size of the device 4 itself in the thickness direction can be reduced compared to a base connector to which the entire plug connector 2 is inserted inside the insertion opening.

As described above, according to the electrical connector of the present embodiment, the base connector 10 having the insertion opening 13a into which the plug connector 2 is inserted, includes the pair of guide portions 14b that are provided so as to be capable of protruding and retracting from both width-direction sides of the insertion opening 13a and that guide both width-direction sides of the plug connector 2 that moves toward the insertion opening 13a.

Accordingly, when the plug connector 2 is inserted into the insertion opening 13a, the plug connector 2 can be guided in the width direction toward the insertion opening 13a and inserted into the insertion opening 13a in an appropriate posture, so that it is possible to suppress damage to the contacts 11 and to easily perform the operation of inserting the plug connector 2 into the insertion opening 13a.

The pair of guide portions 14b are preferably formed integrally with the main body portion 14a that moves to open and close the insertion opening 13a, and preferably protrude from both width-direction sides of the insertion opening 13a as the main body portion 14a moves to open the insertion opening 13a.

Thus, since the pair of guide portions 14b can be protruded to the outside of the insertion opening 13a by the operation of the main body portion 14a that opens the insertion opening 13a, the operation of inserting the plug connector 2 into the insertion opening 13a can be performed more easily.

The main body portion 14a preferably includes the locking portions 14a1 that lock the plug connector 2 inserted into the insertion opening 13a.

Thus, since the plug connector 2 can be locked outside the insertion opening 13a, the insertion depth of the plug connector 2 into the insertion opening 13a can be reduced, and the size in the thickness direction of the device on which the base connector 10 is mounted can be reduced, whereby the size of the device on which the base connector 10 is mounted can be reduced.

In addition, it is preferable to include the posture holding protrusions 13c as posture holding structures that hold the posture of the guide portions 14b in the protruded or retracted position with respect to the insertion opening 13a.

Thus, since the posture of the guide portions 14b closing the insertion opening 13a and the posture of the guide portion 14b opening the insertion opening 13a can be held, the contacts 11 of the base connector 10 can be protected when the device is not used, and the operation of inserting the plug connector 2 into the insertion opening 13a can be more easily performed.

### Second Embodiment

With respect to the base connector 10 as the electrical connector of the present embodiment, the cover 14 is made of a metallic member having conductivity, and is connected to the ground of the substrate 1.

With respect to the base connector 10 configured as described above, if the plug connector 2 is charged due to static electricity when the plug connector 2 is inserted from the insertion opening 13a, the plug connector 2 contacts the cover 14 and thereby electricity is discharged from the plug connector 2 to the ground of the substrate 1 via the cover 14.

As described above, according to the electrical connector of the present embodiment, as in the first embodiment, when the plug connector 2 is inserted into the insertion opening 13a, the plug connector 2 can be guided in the width direction toward the insertion opening 13a and inserted into the insertion opening 13a in an appropriate posture, so that damage to the contacts 11 can be suppressed and the operation of inserting the plug connector 2 into the insertion opening 13a can be easily performed.

It is preferable that the pair of guide portions 14b each are made of a conductive member and is connected to the ground.

Thereby, when the plug connector 2 inserted into the insertion opening 13a is charged, the plug connector 2 contacts the guide portion 14b and thereby electricity is discharged. Thus, the deterioration in the communication performance between the devices connected by the communication cable can be suppressed.

### Third Embodiment

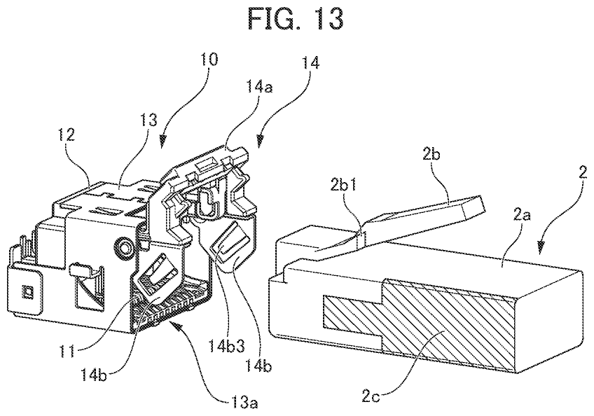

FIG. 13 shows a third embodiment of the present invention, and is a perspective view of a base connector and a plug connector.

With respect to the base connector 10 as the electrical connector of the present embodiment, the cover 14 is made of a metallic member having conductivity, and is connected to the ground of the substrate 1. Each of the pair of guide portions 14b of the cover 14 includes a contact portion 14b3 that is elastic and protrudes inward in the width direction to contact the outer surface of the plug connector 2 inserted into the insertion opening 13a.

The plug connector 2 of the present embodiment is used for a communication cable having a shield layer, and shields 2c are formed on both side surfaces of the housing 2a in the width direction.

With respect to the base connector 10 configured as described above, when the plug connector 2 is inserted into the insertion opening 13a, the contact portions 14b3 of the pair of guide portions 14b contact the shields 2c of the plug connector 2. This makes it possible to form shields in portions of the plug connector 2 in the communication cable having the shield layer.

As described above, according to the electrical connector of the present embodiment, as in the first and second embodiments, when the plug connector 2 is inserted into the insertion opening 13a, the plug connector 2 can be guided in the width direction toward the insertion opening 13a and inserted into the insertion opening 13a in an appropriate posture, so that damage to the contacts 11 can be suppressed and the operation of inserting the plug connector 2 into the insertion opening 13a can be easily performed.

It is preferable that the pair of guide portions 14b each include the contact portions 14b3 that contacts the plug connector 2 inserted into the insertion opening 13a.

This makes it possible to form the shields in the portions of the plug connector 2 in the communication cable having the shield layer, thereby improving the communication performance.

In the above-described embodiments, a personal computer is shown as a device on which the base connector 10 is mounted, but the present invention is not limited thereto, and the electrical connector of the present invention can be applied as long as the device is a device to which a cable is connected.

In the above-described embodiments, the pair of guide portions 14b in the width direction are integrally formed with the main body portion 14a that opens and closes the insertion opening 13a, but only the pair of guide portions that can protrude and retract from both width-direction sides of the insertion opening may be formed, without including the main body portion that opens and closes the insertion opening.

In the above-described embodiments, although the plug connector 2 includes the operation lever 2b in which the engagement portions 2b1 to engage with the locking portions 14a1 of the base connector 10 are formed, the present invention can be applied to a base connector to which a plug connector including no operation lever is coupled.

### EXPLANATION OF REFERENCE NUMERALS

2 plug connector
10 base connector
13a insertion opening
13c posture holding protrusion
14 cover
14a main body portion
14a1 locking portion
14b guide portion
14b3 contact portion

What is claimed is:

1. An electrical connector having an insertion opening into which a plug connector is inserted, the electrical connector comprising:
a pair of guide portions provided so as to be capable of protruding and retracting from both width-direction sides of the insertion opening, the pair of guide portions being configured to guide both width-direction sides of the plug connector that moves toward the insertion opening.

2. The electrical connector according to claim 1, wherein
the pair of guide portions are integrally formed with a main body portion configured to move to open and close the insertion opening, and
protrude from the both width-direction sides of the insertion opening as the main body portion moves to open the insertion opening.

3. The electrical connector according to claim 2, wherein
the main body portion includes a locking portion configured to lock the plug connector inserted into the insertion opening.

4. The electrical connector according to claim 1, further comprising
a posture holding structure configured to hold a posture of the pair of guide portions in a protruded or retracted position with respect to the insertion opening.

5. The electrical connector according to claim 1, wherein
the pair of guide portions each are made of a conductive member and are connected to ground.

6. The electrical connector according to claim 5, wherein
the pair of guide portions each include a contact portion that contacts the plug connector inserted into the insertion opening.
